(19) United States
(12) Patent Application Publication
(10) Pub. No.: US 2008/0061649 A1
(43) Pub. Date: Mar. 13, 2008

(54) Axial gap motor and method for manufacturing the same

(75) Inventors: Han Gee Kim, Gimhae-si (KR); Jung Hyun Park, Gimhae-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/645,182

(22) Filed: Dec. 26, 2006

(30) Foreign Application Priority Data
Sep. 8, 2006 (KR) 10-2006-0086890
Sep. 28, 2006 (KR) 10-2006-0094631

(51) Int. Cl. H02K 21/12; H02K 1/22

(52) U.S. Cl. 310/156.32; 310/268

(57) ABSTRACT

Disclosed is an axial gap motor in which a stator and a rotor are arranged parallel to a rotating shaft. More particularly, an axial gap motor, which can be easily manufactured and achieve an improvement in efficiency, is disclosed. In the axial gap motor the stator includes a back yoke defining a magnetic path, a plurality of stator cores each having a central portion parallel to the rotating shaft, each of the plurality of stator cores being coupled to the back yoke, and a plurality of stator coils each wound around the central portion of a corresponding one of the stator cores.

This application claims the benefit of Korean Patent Application No. 10-2006-0086890 filed on Sep. 8, 2006 and No. 10-2006-0094631 filed on Sep. 28, 2006 which are hereby incorporated by reference as if fully set forth herein.

### BACKGROUND OF THE INVENTION

1. Field of the Invention

The present invention relates to an axial gap motor in which a stator and a rotor are arranged parallel to a rotating shaft, and more particularly, to an axial gap motor which can be easily manufactured and achieve an improvement in efficiency.

2. Discussion of the Related Art

Generally, axial gap motors are configured in such a manner that a gap is defined between a stator and a rotor so as to be parallel to a rotating shaft, differently from other motors in which the gap is defined radially. For example, in the case of inner rotor motors, a rotor is located inside a stator in a radial direction of the stator. On the other hand, in the case axial gap motors, a rotor is located above or below a stator. Such an axial gap motor has an advantage of a very thin thickness and therefore, can be used as a motor for driving compact-size home electronics, FD drives, or the like.

Now, a conventional axial gap motor will be described in detail with reference to FIG. 1.

As shown in FIG. 1, a stator 10 provided in the conventional axial gap motor includes a back yoke 11 that is made of a magnetic material so as to define a magnetic path, and a plurality of stator coils 12 coupled to the back yoke 11. The plurality of stator coils 12 are wound about predetermined radial positions of the back yoke 11, respectively, so that they are arranged in a circumferential direction of the back yoke 11. In this case, generally, each stator coil defines a magnetic pole.

As one example, in the case of an axial gap BLDC motor of three-phase and six-pole type, six stator coils are provided and two stator coils are allotted to each phase, so as to define a total of six poles of three phases.

Meanwhile, a rotor 20 is located in an axial direction of the stator 10 so that the rotor 20 has a predetermined gap with the stator 10 along the axial direction of the stator 10. The rotor 20 includes a plurality of permanent magnets 21 arranged to face the stator coils 12. The permanent magnets 21 are attached to a permanent magnet frame 22 so that they are arranged along a circumferential direction of the permanent magnet frame 22.

A rotating shaft 30 is penetrated through the center of the permanent magnet frame 22 to thereby be fixedly maintained by the frame 22. As the rotor 20, which includes the permanent magnet frame 22 and the permanent magnets 21, is rotated, the rotating shaft 30 is simultaneously rotated. Here, the rotating shaft 30 is secured to the permanent magnet frame 22 through a bushing 40.

The above described axial gap motor may further include a bracket for receiving the stator 10 and the rotor 20 therein. The bracket is divided into an upper bracket (not shown) and a lower bracket 51.

The stator 10 is secured to the lower bracket 51, and the rotor 20 is rotably supported in both the upper bracket and the lower bracket 51 through a bearing 61 mounted at a lower bracket 51 and a bearing 62 mounted at the upper bracket (not shown).

Not described reference numeral “70” denotes a hole sensor for sensing the position and speed of the rotor 20.

Hereinafter, a method for manufacturing the conventional axial gap motor as shown in FIG. 1 will be described.

First, after preparing the stator coils 12, the stator coils 12 are positioned on the back yoke 11 to have a predetermined distance therebetween. Then, the stator coils 12 are subject to a molding process, such that the stator coils 12 are wholly enclosed by a molded structure 13. With the use of the molded structure 13, the stator coils 12 are mounted on the back yoke 11 at fixed positions. The molded structure 13 also serves to insulate the stator coils 12.

The above described method for manufacturing the conventional axial gap motor, however, has a problem of complexity because the stator coils should be formed previously via a separate process. Further, positioning the stator coils on the back yoke with a predetermined distance therebetween is very difficult and securing the stator coils at fixed positions by a molding process is also very troublesome. Since the stator coils included in the conventional axial gap motor have an approximately planar shape, it is very difficult to mold the previously formed planar stator coils on the back yoke while maintaining the original shape of the stator coils.

Furthermore, the axial gap motor manufactured by the above described method has no stator core on which the stator coils are wound and therefore, suffers from deterioration in efficiency due to the leakage of magnetic flux from the interior of the stator coils.

### SUMMARY OF THE INVENTION

Accordingly, the present invention is directed to an axial gap motor and a method for manufacturing the same that substantially obviate one or more problems due to limitations and disadvantages of the related art.

An object of the present invention is to provide an axial gap motor capable of being easily manufactured.

Another object of the present invention is to provide an axial gap motor capable of minimizing the leakage of magnetic flux, thereby achieving an increase in efficiency.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an axial gap motor comprising: a rotating shaft, a stator and a rotor, wherein the stator includes: a back yoke defining a magnetic path; a plurality of stator cores each having a central portion parallel to the rotating shaft, wherein each of the plurality of stator cores is coupled to the back yoke; and a plurality of stator coils each wound around the central portion of a corresponding one of the stator cores.

The stator cores are coupled to the surface of the back yoke. The coupling of the stator cores may be accomplished in various manners. In one example, the plurality of stator cores may be inserted into recesses formed in the surface of the back yoke, so as to be coupled to the back yoke. In another example, screws may be penetrated through the center of the respective stator cores to couple the plurality of stator cores to the back yoke. Of course, both the recesses and the screws may be employed to achieve a coupling between the stator cores and the back yoke.

Preferably, the plurality of stator cores are coupled to the back yoke after the stator coils are wound on the stator cores. Of course, it is allowable that the stator coils are wound on the stator cores after the stator cores are coupled to the back yoke.

Preferably, the plurality of stator cores are formed by compressing a fiber-reinforced thermosetting compound. The fiber-reinforced thermosetting compound is called “BMC” “SMC” and well known in the fields of chemistry and chemical industry. With the use of this kind of material having a high formability, the stator cores can be manufactured to have a variety of shapes while achieving strong magnetic characteristics.

The stator cores may be made of magnetic plastic, which has a high formability and strong magnetic force. Accordingly, the stator cores made of magnetic plastic are efficient to minimize the leakage of magnetic flux.

An insulating material is interposed between each stator core and an associated one of the stator coils.

Preferably, each stator core has a centrally cut-away fan-shaped planar tip end portion. Accordingly, when all the stator cores are coupled to the back yoke, the stator cores constitute an annular plate. Preferably, each stator core has a T-shaped longitudinal sectional shape at the center thereof.

In accordance with another aspect of the present invention, there is provided a method for manufacturing an axial gap motor comprising: forming a plurality of stator cores; winding each of a plurality of stator coils on a corresponding one of the stator cores, wherein the stator cores are arranged parallel to a rotating shaft; and coupling the stator cores to a back yoke so that the stator cores are circumferentially spaced apart from one another by a predetermined angle.

Preferably, the stator cores are made of a magnetic material. In particular, the stator cores may be formed by compressing a fiber-reinforced thermosetting compound, or by injection molding magnetic plastic.

The above described axial gap motor according to the present invention has the following effects.

Firstly, with the use of the stator cores made of a magnetic material, it is possible minimize the leakage of magnetic flux from the interior and upper side of the stator coils. This has the effect of providing the axial gap motor with an increased efficiency.

Secondly, as a result of winding the stator coils on the stator cores while allowing the stator coils to be coupled to the back yoke through the stator cores, it is possible to achieve not only easy winding of the stator coils, but also accurate and stable positioning of the stator coils at fixed positions.

Thirdly, the present invention can eliminate the use of separate molded structures that have been conventionally used to secure the stator coils at fixed positions while insulating the stator coils. This has the effect of further simplifying the manufacture of the axial gap motor.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view illustrating a conventional axial gap motor;

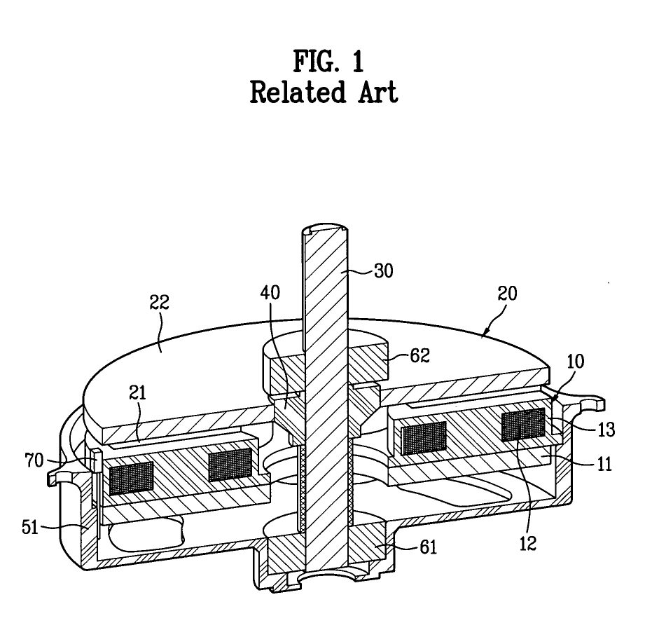

FIG. 2 is a perspective view illustrating a stator provided in an axial gap motor according to the present invention; and

FIG. 3 is a sectional view illustrating an axial gap motor according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

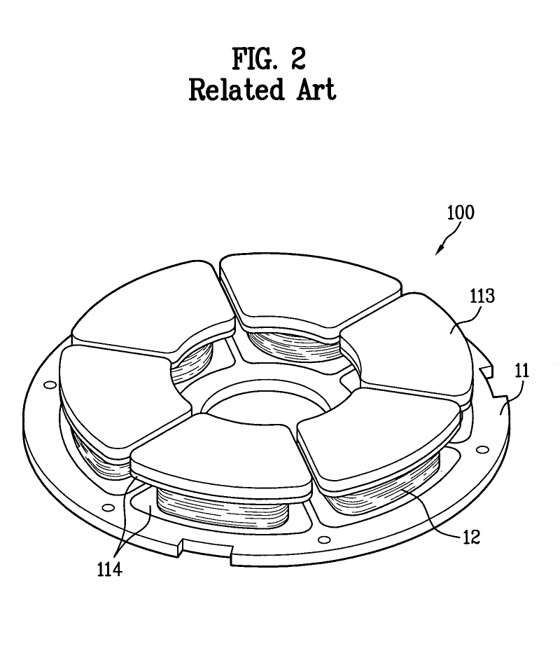

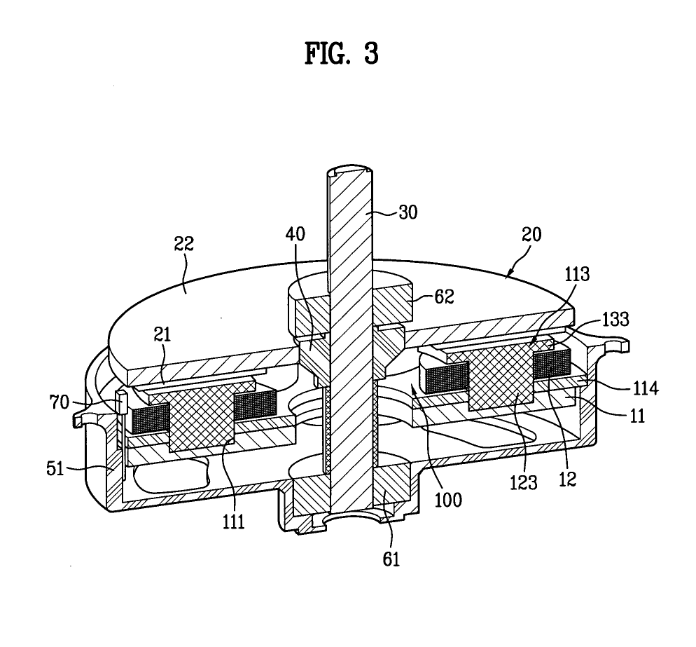

Now, an axial gap motor according to the present invention will be explained in detail with reference to FIGS. 2 and 3.

FIG. 2 is a perspective view illustrating a stator 100 provided in the axial gap motor according to the present invention.

As shown in FIG. 2, the stator 100 provided in the axial gap motor according to the present invention includes a back yoke 11, stator cores 113, and stator coils 12. For the mutual insulation of the stator coils 12, back yoke 11, and stator cores 113, an insulating material, such as an insulating sheet, is included in the stator 100.

Of course, the insulating sheet may be substituted by a bobbin (not shown) that is made of an insulating material. When using the bobbin, after winding each stator coil 12 on the bobbin, an associated one of the stator cores 113 is inserted into the bobbin. In this case, the stator coil is wound on a center portion of the bobbin and the bobbin has sidewalls formed at opposite sides of the center portion thereof. By virtue of the sidewalls thereof, the bobbin can achieve the mutual insulation of the associated stator coil 12, back yoke 11, and stator core 113. The configuration and effects of the bobbin and the insulating sheet are well known in the field of motors and thus, a detailed description thereof will be omitted.

As shown in FIG. 3, each stator core 113 is previously formed separately from the back yoke 11 and coupled to the surface of the back yoke 11. The coupling of the stator core 113 and the back yoke 11 may be accomplished in various manners.

For example, the back yoke 11 may be formed, at the surface thereof, with recesses 111 so that the stator cores 113 are inserted into the recesses 111, respectively, to thereby be coupled to the back yoke 11.

Although not shown, alternatively, screws may be penetrated through the center of the respective stator cores 113 from the upper side of the stator cores 113, so as to couple the stator cores 113 to the back yoke 11. Of course, both the recesses 111 and the screws (not shown) may be employed, to achieve an easy and strong coupling between the stator cores 113 and the back yoke 11.

For reference, FIG. 3 illustrates no insulating sheet between the stator cores 113 and the stator coils 12.

As shown in FIGS. 2 and 3, the stator cores 113 preferably have a T-shaped cross sectional shape. Each stator core 11 3 has a body portion 123, around which the stator coil 12 is wound, and a planar portion 133 defining a tip end portion of the stator core 113.

Here, one end of the body portion 123 is coupled to the back yoke 11 via the associated recess 111, etc., so as to be maintained at a fixed position. The other end of the body portion 123 is connected to the planar portion 133.

The planar portion 133, which defines the tip end portion of the stator core 113, has a centrally cut-away fan shape as shown in FIG. 2. Preferably, as shown in FIG. 2, the planar portion 133 is shaped to completely cover the stator coil 12. In FIG. 3 is illustrated a configuration in that only a part of the stator coil 12 is covered.

In a state wherein all the stator cores 113 are coupled to the back yoke 11, as shown in FIG. 2, the planar portions 133 of the stator cores 113 define an annular profile. In the present invention, a magnetic path is defined by the planar portions 133 of the stator cores 113 and this has the effect of preventing the leakage of magnetic flux generated from the stator coils 12, resulting in an improvement in the efficiency of the axial gap motor.

Preferably, the stator cores 113 are made of a magnetic material. That is, in addition to enabling winding of the stator coils and supporting the wound stator coils, the stator cores 113 have the function of defining a magnetic path therein in order to minimize the leakage of magnetic flux.

In conventional motors, generally, there is provided a stator core, which is formed by stacking tartar steel plates one above another. However, it is very difficult to manufacture the stator core to have a variety of shapes by using the tartar steel plates.

For this reason, the axial gap motor according to the present invention includes the plurality of stator cores 113, and the stator cores 113 may be formed by compressing a fiber-reinforced thermosetting compound. The fiber-reinforced thermosetting compound is known as BMC or SMC and has very excellent formability. Further, the fiber-reinforced thermosetting compound may provide the stator cores 113 with a stronger magnetic strength than the conventional stack of tartar steel plates. Accordingly, with the use of the stator cores 113, the leakage of magnetic flux generated in the center of the respective stator coils 12 can be minimized and thus, the resulting axial gap motor of the present invention can achieve an increase in efficiency.

Furthermore, the planar portion 133 provided at the stator core 113 serves to more efficiently restrict the leakage of magnetic flux, resulting in an increase in efficiency. In conclusion, according to the present invention, a closed magnetic path is defined actually, to minimize the leakage of magnetic flux and consequently, maximize the efficiency of the motor.

Alternatively, the stator core 113 may be made of magnetic plastic. The magnetic plastic also has an excellent formability because magnetic particles can be easily injection molded into plastic. The use of the magnetic plastic enables the formation of a stator core having a relatively complicated shape because the magnetic plastic serves as a material capable of being easily molded as occasion demands, in addition to serving as a magnetic material. The magnetic plastic also serves as an insulating material. Therefore, there is no necessity for the insulating sheet, etc., for the sake of mutual insulation of the stator coils 12 and the stator cores 113.

Hereinafter, a method for manufacturing the axial gap motor according to the present invention, more particularly, a method for manufacturing the stator included in the axial gap motor, will be explained in detail with reference to FIG. 3.

First, the stator cores are prepared. As described above, the stator cores are made of a magnetic material. Preferably, the stator cores may be formed by compressing a fiber-reinforced thermosetting compound, or formed via the injection molding of magnetic plastic.

Then, the stator coils are wound on the respective stator cores. The winding of the stator coils is accomplished in a direction parallel to a rotating shaft.

Thereafter, the stator cores, on which the stator coils were wound, are coupled to the surface of the back yoke so that the stator cores are circumferentially spaced apart from one another by a predetermined angle. In this case, the coupling of the stator cores may be accomplished by inserting the stator cores into the recesses formed in the surface of the back yoke, or by fastening screws, etc. through the stator cores and the back yoke.

In conclusion, in the method for manufacturing the axial gap motor according to the present invention, as a result of winding the stator coils on the stator cores, the winding and fixation of the stator coils can be easily accomplished.

It will be apparent to those skilled in the art that various modifications and variations can be made in the present invention without departing from the spirit or scope of the inventions. Thus, it is intended that the present invention covers the modifications and variations of this is invention provided they come within the scope of the appended claims and their equivalents.

What is claimed is:

1. An axial gap motor comprising:
a rotating shaft, a stator and a rotor,
wherein the stator includes:
a back yoke defining a magnetic path;
a plurality of stator cores each having a central portion parallel to the rotating shaft, wherein each of the plurality of stator cores is coupled to the back yoke; and
a plurality of stator coils each wound around the central portion of a corresponding one of the stator cores.

2. The axial gap motor according to claim 1, wherein the plurality of stator cores are coupled to the surface of the back yoke.

3. The axial gap motor according to claim 2, wherein each of the plurality of stator cores is coupled to the back yoke as the stator cores are inserted into recesses formed at the surface of the back yoke.

4. The axial gap motor according to claim 2, wherein the plurality of stator cores are coupled to the back yoke with screws, such that the screws penetrate through the center of the respective stator cores.

5. The axial gap motor according to claim 2, wherein the plurality of stator cores are coupled to the back yoke after the stator coils are wound on the stator cores.

6. The axial gap motor according to claim 1, wherein the plurality of stator cores are formed by compressing a fiber-reinforced thermosetting compound.

7. The axial gap motor according to claim 6, wherein an insulating material is interposed between each stator core and an associated stator coil.

8. The axial gap motor according to claim 6, wherein each stator core has a cut-away fan-shaped planar tip end portion.

9. The axial gap motor according to claim 6, wherein each stator core has a T-shaped longitudinal sectional shape at the center thereof.

10. An axial gap motor comprising:
a rotating shaft, a stator and a rotor,
wherein the stator includes:
a back yoke defining a magnetic path;
a plurality of stator cores each having a central portion parallel to the rotating shaft, wherein each of the of the plurality of stator cores is coupled to the back yoke, the plurality of stator cores being made of a magnetic material; and
a plurality of stator coils each wound around the central portion of a corresponding one of the plurality of stator cores.

11. The axial gap motor according to claim 10, wherein the plurality of stator cores are made of insulating magnetic plastic.

12. The axial gap motor according to claim 10, wherein the plurality of stator cores are formed by compressing a fiber-reinforced thermosetting compound.

13. The axial gap motor according to claim 11, wherein the plurality of stator cores are coupled to a surface of the back yoke.

14. The axial gap motor according to claim 12, wherein the plurality of stator cores are inserted into recesses formed at on the surface of the back yoke, respectively.

15. The axial gap motor according to claim 12, wherein the plurality of stator cores are coupled to the back yoke with screws, such that the screws penetrate through the center of the respective stator cores.

16. The axial gap motor according to claim 12, wherein the stator cores are coupled to the back yoke after the stator coils are wound on the stator cores.

17. The axial gap motor according to claim 15, wherein each stator core has a centrally cut-away fan-shaped planar tip end portion.

18. The axial gap motor according to claim 15, wherein each stator core has a T-shaped longitudinal sectional shape at the center thereof.

19. A method for manufacturing an axial gap motor comprising:
forming a plurality of stator cores;
winding each of a plurality of stator coils on a corresponding one of the stator cores, wherein the stator cores are arranged parallel to a rotating shaft; and
coupling the stator cores to a back yoke so that the plurality of stator cores are circumferentially spaced apart from one another by a predetermined angle.

20. The method according to claim 19, wherein the plurality stator cores are made of a magnetic material.

21. The method according to claim 19, wherein the plurality of stator cores are made of magnetic plastic.

22. The method according to claim 19, wherein the plurality of stator cores are formed by compressing a fiber-reinforced thermosetting compound.
